(19) United States
(12) Patent Application Publication
(10) Pub. No.: US 2007/0027774 A1
(43) Pub. Date: Feb. 1, 2007

(54) Broadcast system, broadcast time selling machine, censor server device and broadcast time selling machine control program

(75) Inventors: Daisuke Utsunomiya, Asaka-shi (JP); Junji Hayashi, Tokyo (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Minami-Ashigara-shi (JP)

(21) Appl. No.: 11/492,147

(22) Filed: Jul. 25, 2006

(30) Foreign Application Priority Data
Jul. 26, 2005 (JP) 2005-215866

(51) Int. Cl. G06Q 20/00

(52) U.S. Cl. 705/16

(57) ABSTRACT

A broadcast system, comprising: a street television device, and a broadcast time selling machine connected to the street television device, which sells a broadcast time for broadcasting desired contents, wherein the broadcast time selling machine comprises: a reading device which reads a contents file in which the contents are recorded; a storage device which stores the contents file; an input device which accepts an input of the broadcast time at which the contents are preferred to be broadcasted from a user; a settlement device which makes settlement of an expenditure required for broadcasting the contents; and a control device which controls to broadcast the contents on the street television device at the broadcast time.

### BACKGROUND OF THE INVENTION

1. Field of the Invention

The present invention relates to a broadcast system, a broadcast time selling machine, a censor server device and a broadcast time selling machine control program, and the present invention particularly relates to a technique which permits a personal purchase of a broadcast right for a street television device.

2. Description of the Related Art

Conventionally, it is practiced to make a contract with a broadcast company which manages the street television device, to display a desired advertisement on the street television device.

Japanese Patent Application Laid-Open No. 2003-125379 discloses an information supply system which broadcasts information such as an advertisement or contents suitable for a user on the street television device. When the user approaches the street television device, this information supply system begins broadcasting the advertisement suitable for the user among advertisement data previously stored in a server device, based on position information and personal information which have been acquired through a cellular phone and the like.

### SUMMARY OF THE INVENTION

However, in order to broadcast an advertisement on a street television device, there has been a problem in which it is necessary to previously make a contract with a broadcast company and a procedure for making the contract is cumbersome. Moreover, since a broadcast right fee is expensive for an individual to broadcast desired contents including the advertisement, there has been a problem in which the street television device cannot function as a medium available to the individual.

The present invention has been made in view of the above described problems, and it is an object of the present invention to solve cumbersomeness in the contract procedure and to provide a technique which permits everyone to readily utilize the street television device.

In order to attain the above described object, a broadcast system according to the present invention is a broadcast system including a street television device and a broadcast time selling machine connected to the street television device, which sells a broadcast time for broadcasting desired contents, wherein the above described broadcast time selling machine includes a reading device which reads a contents file in which the above described contents are recorded, a storage device which stores the above described contents file, an input device which accepts an input of the broadcast time at which the above described contents are preferred to be broadcasted from a user, a settlement device which makes settlement of an expenditure required for broadcasting the above described contents, and a control device which controls to broadcast the above described contents on the above described street television device at the above described broadcast time.

Accordingly, when the broadcast time is inputted by use of a broadcast time vending machine connected to the street television device, and the settlement of the expenditure required for broadcasting is made, it is possible to broadcast the contents on the street television device.

Moreover, the broadcast system further includes a waiting signal attachment device which attaches a waiting signal for indicating that the broadcast is waited for, to the above described contents file stored in the above described storage device, and a permission signal acquisition device which acquires a permission signal for canceling the above described waiting signal and permitting the broadcast, wherein when the above described permission signal is acquired, the control device cancels the above described waiting signal attached to the above described contents file, and controls to broadcast the above described contents on the above described street television device at the above described broadcast time.

The permission signal acquisition device may be a device in which the permission signal is inputted by use of an operation device such as a keyboard or a touch panel provided on the street television device, or may be a device which receives the permission signal via a network. Moreover, the permission signal may be previously attached to the contents file which has been censored and permitted to be broadcasted once, and the permission signal acquisition device may be configured as a device which reads this attached permission signal.

Accordingly, the broadcast may be performed only if the read contents file has been permitted to be broadcasted.

Moreover, a censor server device which censors the above described contents may be connected to the above described broadcast time selling machine, the above described broadcast time selling machine may include a replication device which generates a replication of the above described contents file, a selling machine sending device which sends the replication of the above described contents file with respect to the above described censor server device, and a selling machine receiving device which receives the above described permission signal from the above described censor server device, and the above described censor server device may include a censor server receiving device, which receives the replication of the above described contents file from the above described broadcast time selling machine, a permission signal generation device which generates the above described permission signal if the broadcast is permitted, as a result of censoring the above described contents based on the replication of the above described contents file, and a censor server sending device which sends the above described permission signal to the above described broadcast time selling machine.

Accordingly, it is possible to broadcast the contents on the street television device, only if the contents have the substance which may be broadcasted.

Moreover, the broadcast system according to the present invention is a broadcast system in which street television devices, a broadcast time selling machine which sells a broadcast time for broadcasting desired contents on the street television devices, and a broadcast server device which controls to broadcast on the above described street television devices, are connected via a network, wherein the above described broadcast time selling machine includes a reading device which reads a contents file in which the above described contents are recorded, a storage device which stores the above described contents file, an input device which accepts an input of the broadcast time at which the above described contents are preferred to be broadcasted from a user, a settlement device which makes settlement of an expenditure required for broadcasting the above described contents, and a selling machine sending device which sends the above described contents file and broadcast time information indicating the above described broadcast time, and wherein the above described broadcast server device includes a broadcast server receiving device which receives the above described contents file and the above described broadcast time information, and a control device which controls to broadcast on the above described street television devices at the above described broadcast time, based on the above described contents file and the above described broadcast time information.

Accordingly, when the broadcast time is inputted by use of the broadcast time vending machine connected to the street television devices, and the settlement of the expenditure required for broadcasting is made, it is possible to broadcast the contents on the street television devices. Moreover, since even the street television devices which are not connected directly to the broadcast time selling machine can broadcast the desired contents through the broadcast control by the broadcast server device, it is also possible to purchase the broadcast time on the street television devices at a remote location from the broadcast time selling machine.

Moreover, at least one of the above described street television devices is connected to the above described network, the broadcast system further includes a selection device which have the user select the above described street television device on which the user prefers to broadcast among the above described street television devices, and wherein the above described control device controls to broadcast on the above described street television device which has been selected by the above described selection device.

Accordingly, if there are a plurality of streets television devices, it is possible to select a preferred street television device and broadcast the contents thereon.

Moreover, the broadcast system according to the present invention is a broadcast system in which a terminal device, street television devices, and a broadcast server device which controls to broadcast on the above described street television devices, are connected via a network, and the broadcast system is characterized wherein the above described terminal device includes a reading device which reads a contents file in which contents preferred to be broadcasted are recorded, a selection device which selects the above described street television device on which the above described contents are preferred to be broadcasted, an input device which accepts an input of a broadcast time at which the above described contents are preferred to be broadcasted on the above described street television device, a terminal side receiving device which receives expenditure information required for broadcasting the above described contents, and a terminal sending device which sends the above described contents file, broadcast time information indicating the above described broadcast time and settlement information with respect to the above described expenditure information, and wherein the above described broadcast server device includes a broadcast server receiving device which receives the above described contents file, the above described broadcast time information and the above described settlement information, a control device which controls to broadcast on the above described street television device at the above described broadcast time, based on the above described contents file and the above described broadcast time information, an expenditure calculation device which calculates an expenditure for broadcasting the above described contents file, and a broadcast server sending device which sends the above described expenditure information indicating a calculation result by the above described expenditure calculation device to the above described terminal device.

Accordingly, it is possible to request the broadcast of the contents and make settlement thereof with respect to the broadcast server device from the terminal device, and to purchase a broadcast right also from a personal computer at home of the user.

Moreover, a censor server device which censors the above described contents is connected to the above described network, the above described selling machine sending device or the above described terminal sending device sends the above described contents file and the above described broadcast time information to the above described censor server device, and the above described censor server device includes a censor server receiving device which receives the above described contents file and the above described broadcast time information, and a transferring device which transfers the above described contents file and the above described broadcast time information with respect to the above described broadcast server device if the broadcast is permitted, as a result of censoring the above described contents based on the above described contents file.

Accordingly, it is possible to determine whether or not the contents have the substance which may be broadcasted.

Moreover, the above described broadcast time selling machine further includes an expenditure calculation device which calculates the expenditure required for broadcasting, based on at least one of the length of the above described broadcast time and an audience number which may be expected in the case of broadcasting the above described contents at the above described broadcast time, or the expenditure calculation device of the above described broadcast server device calculates the expenditure required for broadcasting, based on at least one of the length of the above described broadcast time and the audience number which may be expected in the case of broadcasting the above described contents at the above described broadcast time.

Accordingly, it is possible to calculate the broadcast expenditure depending on whether the broadcast time is long or short, or demands for the broadcast.

Moreover, the above described broadcast time selling machine or the above described terminal device further includes a contact information acceptance device which accepts an input of contact information required for performing a refund process with respect to the above described user, the above described selling machine sending device or the above described terminal sending device sends the above described contact information to any one of the above described broadcast time selling machine, the above described censor server device and the above described broadcast server device, and any one of the above described broadcast time selling machine, the above described censor server device and the above described broadcast server device further includes a refund processing device which receives the above described contact information and performs the refund process based on the contact information.

As a result of censoring the contents, if the contents are determined not to be appropriate for the broadcast, or if a scheduled broadcast has become impossible to be performed due to a failure of the street television device and the like, the refund processing device performs the refund process.

Accordingly, even if a broadcast fee has been previously paid through the broadcast time vending machine, it is possible to perform the refund process depending on whether the broadcast is possible or not.

Moreover, any one of the above described broadcast time selling machine, the above described censor server device and the above described broadcast server device further includes a deleting device which deletes the above described contents file of which the broadcast has been terminated or the above described contents file which is not permitted to be broadcasted.

Accordingly, it is possible to delete the contents file which has become unnecessary, to secure a free space in the storage device.

A broadcast time selling machine according to the present invention includes a reading device which reads a contents file in which contents preferred to be broadcasted on a street television device are recorded, a storage device which stores the above described contents file, an input device which accepts an input of a broadcast time at which the above described contents are preferred to be broadcasted from a user, and a settlement device which makes settlement of an expenditure required for broadcasting the above described contents file.

Accordingly, it is possible to purchase the broadcast time on the street television device without going through the cumbersome contract procedure with the broadcast company.

Moreover, the broadcast time selling machine is connected to the above described street television device, and further includes a waiting signal attachment device which attaches a waiting signal for indicating that the broadcast is waited for, to the above described contents file stored in the above described storage device, a permission signal acquisition device which acquires a permission signal for canceling the above described waiting signal and permitting the broadcast, and a control device which cancels the above described waiting signal attached to the above described contents file when the above described permission signal is acquired, and controls to broadcast on the above described street television device at the above described broadcast time.

Accordingly, it is possible to broadcast only the contents which has been permitted to be broadcasted.

Moreover, a censor server device according to the present invention includes an acquisition device which acquires a contents file in which contents preferred to be broadcasted on a street television device are recorded, and a censor device which determines whether or not the above described contents file corresponds to a broadcast prohibited condition, wherein if the broadcast is permitted as a result of censoring by the above described censor device, the above described contents file is sent with respect to the above described street television device on which the broadcast is performed, or a permission signal for permitting the broadcast is sent with respect to a control device which controls to broadcast on the above described street television device.

Accordingly, it is possible to permit the broadcast of the contents, if the contents have the substance appropriate to be broadcasted.

Moreover, a control program of a broadcast time selling machine according to the present invention causes a computer to execute a reading step of reading a contents file in which contents preferred to be broadcasted are recorded, an input instruction step of accepting an input of a broadcast time for broadcasting the above described contents from a user, a settlement step of making settlement of an expenditure required for the above described broadcast, and a control step of controlling to broadcast the above described contents on a street television device.

According to the present invention, it is possible to provide a technique which solves cumbersomeness in the contract procedure and permits everyone to readily utilize the street television device.

### BRIEF DESCRIPTION OF THE DRAWINGS

FIG. 1 is a general configuration diagram of a broadcast system according to the first embodiment;

FIG. 2 is an external view of a selling machine and a street television device;

FIG. 3 is a block diagram showing a general configuration of the selling machine, the street television device and a censor server device, which configures a broadcast system;

FIG. 4 is a block diagram showing a configuration of programs executed by a system control unit of the selling machine;

FIG. 5 is a block diagram showing a configuration of programs executed by a server control unit of the censor server device;

FIG. 6 is a flowchart showing a process flow of selling a broadcast time through the selling machine;

FIG. 7 is a flowchart showing the process flow after selling the broadcast time through the selling machine;

FIG. 8 is a pattern diagram showing a screen display example of a broadcast time input screen;

FIG. 9 is a pattern diagram showing a screen display example of a contact information input screen;

FIG. 10 is a pattern diagram showing a screen display example of a confirmation screen;

FIG. 11 is a pattern diagram showing a screen display example of a fee display screen;

FIG. 12 is a pattern diagram showing a screen display example of an ending screen;

FIG. 13 is a pattern diagram showing a structure of a contents file management DB to be stored in a HDD;

FIG. 14 is a general configuration diagram of the broadcast system according to the second embodiment;

FIG. 15 is a block diagram showing a general configuration of the selling machine, the censor server device and a broadcast server device according to the second embodiment;

FIG. 16 is a block diagram showing a configuration of programs executed by a broadcast control unit;

FIG. 17 is a sequence diagram illustrating a process flow of the second embodiment;

FIG. 18 is a pattern diagram showing a screen display example of a television selection screen; and

FIG. 19 is a general configuration diagram of the broadcast system according to the third embodiment.

### DETAILED DESCRIPTION OF THE PREFERRED EMBODIMENTS

Hereinafter, the preferred embodiments of a broadcast time selling machine and a broadcast system according to the present invention will be described in detail, according to the attached drawings.

### First Embodiment

[General Configuration of the System]

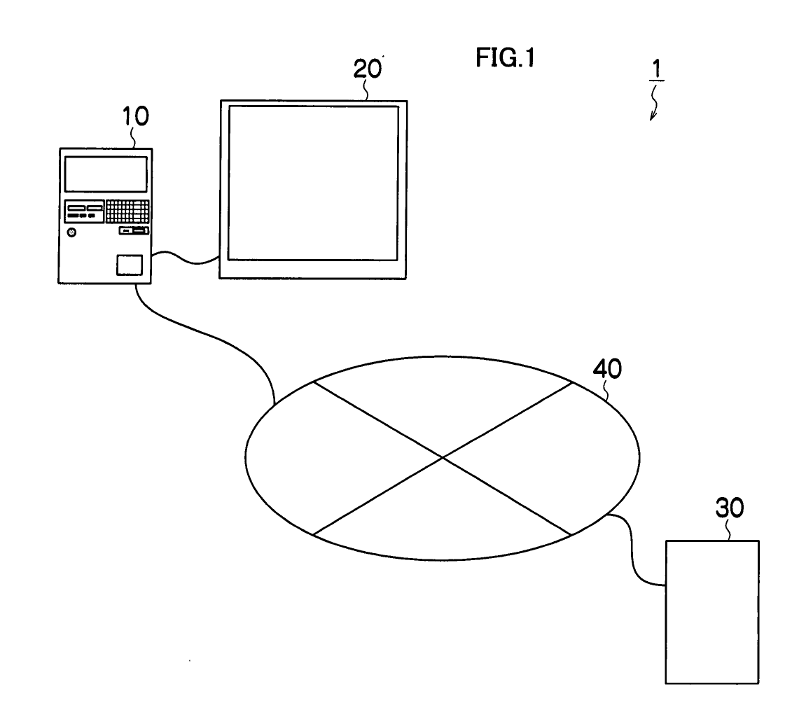

FIG. 1 shows a broadcast system 1 according to the present invention. The broadcast system 1 is configured with a broadcast time vending machine (hereinafter referred to as “selling machine”) 10, a street television device 20 connected to the selling machine 10, a censor server device 30 which censors contents to be broadcasted on the street television device 20, and a network 40 which connects the selling machine 10 and the censor server device 30. The network 40 may be a dedicated line, in addition to a public line network such as the Internet. The street television device 20 may be installed in an indoor location or an outdoor location. If the selling machine 10 and the street television device 20 are installed in an indoor space such as a lobby of a hotel or a station yard, and furthermore the censor server device 30 is installed in the same indoor space such as a management room, the selling machine 10 and the censor server device 30 may be connected with a local area network.

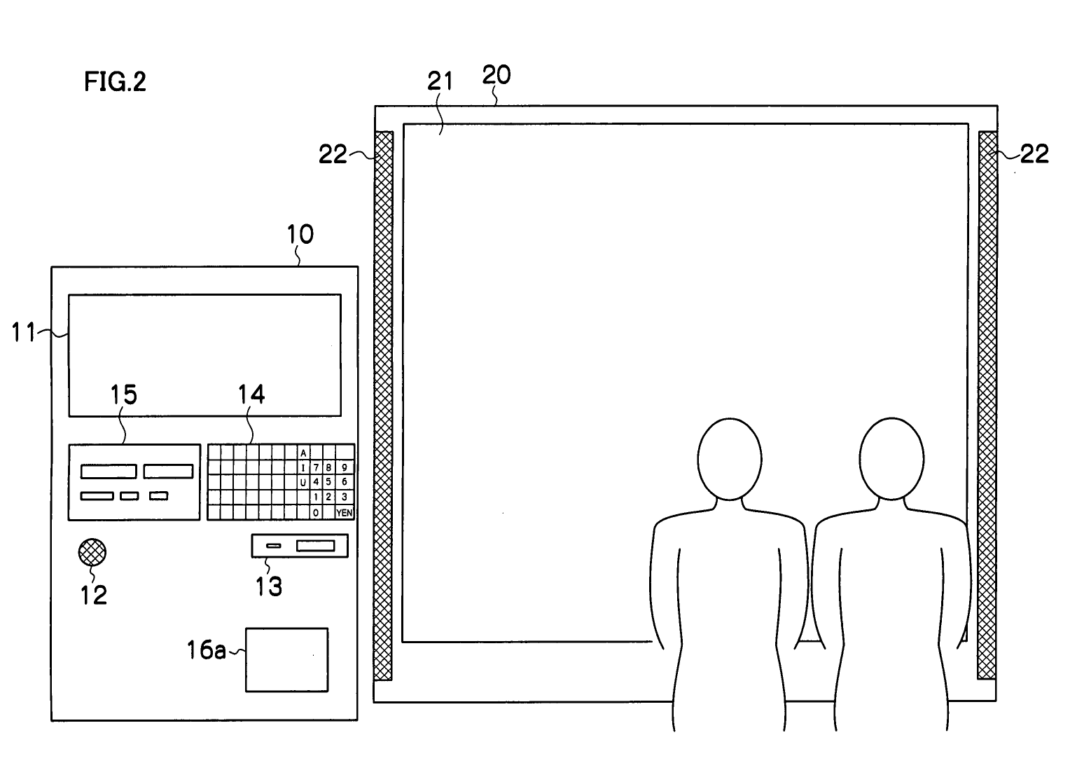

FIG. 2 is an external view of the selling machine 10 and the street television device 20.

The selling machine 10 includes an acceptance monitor 11 which displays the contents for editing or confirming the contents scheduled to be broadcasted, a speaker 12 which outputs an operation guidance of the selling machine 10 or a sound of the contents, a coin/note inlet 13 in which coins and notes are put in for making payment of a broadcast fee, an acceptance operation unit 14 such as a keyboard or a numeric keypad, a media slot 15 in which a medium 15a, including a memory card such as a DVD, a CD, a xD picture card or the like which has stored a contents file thereon, may be inserted, and an outlet 16a through which a receipt or change is taken out. The acceptance operation unit 14 such as the keyboard or the numeric keypad may be configured as a touch panel which is displayed on the acceptance monitor 11. Moreover, payment of the broadcast fee is not limited to a cash settlement, but also a credit card or a debit card, as well as a cellular phone provided with a settlement function may be used. In this case, instead of the coin/note inlet 13, a device which accepts a settlement procedure other than the cash settlement may be provided, such as an inlet of the credit card or the debit card, and a receiving unit for receiving settlement information from the cellular phone.

The street television device 20 includes a large monitor 21 which displays the contents, and a speaker 22 which outputs the sound.

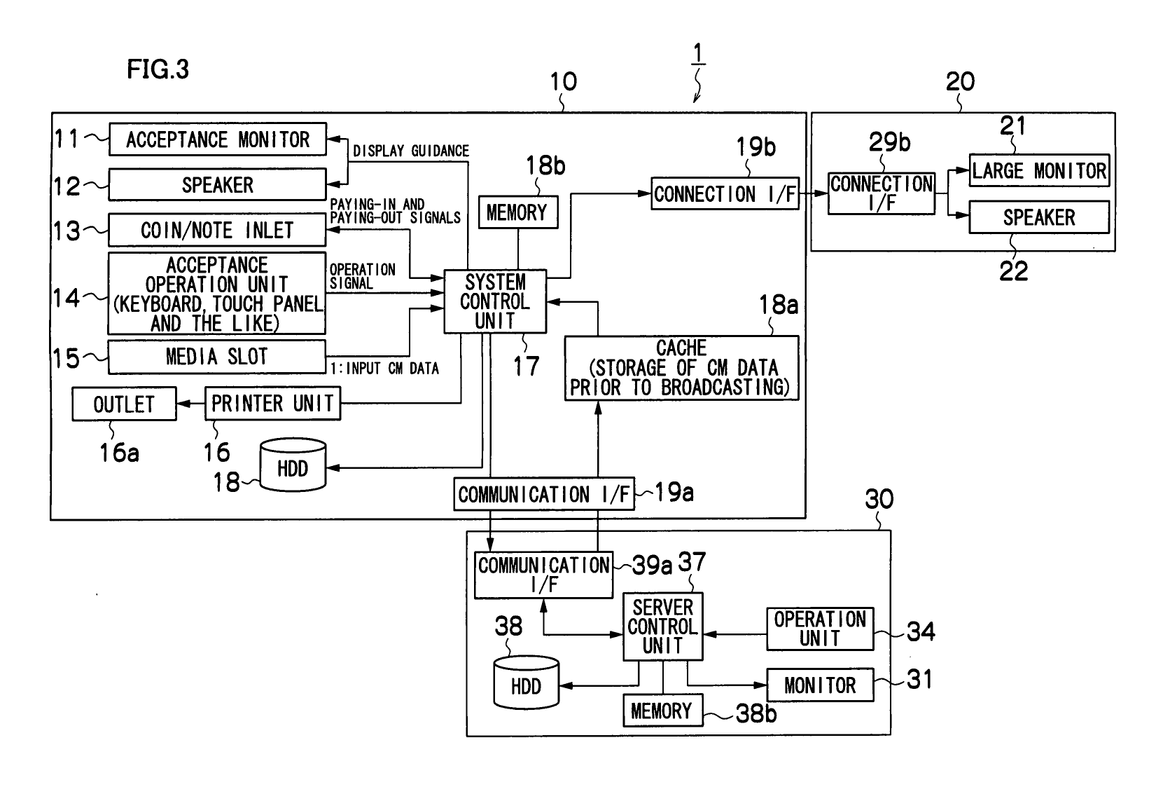

FIG. 3 is a block diagram showing a general configuration of the selling machine 10, the street television device 20 and the censor server device 30, which configure the broadcast system 1.

The selling machine 10 includes the acceptance monitor 11, the speaker 12, the coin/note inlet 13, the acceptance operation unit 14, the media slot 15, a printer unit 16 which prints the receipt and the outlet 16a which ejects the print or the change, a system control unit 17 which controls operations of the selling machine 10 and the street television device 20, a hard disk (hereinafter referred to as “HDD”) 18 which stores the contents file which has been read from the medium 15a inserted into the media slot 15, a cache 18a which temporarily stores the contents to be broadcasted, immediately prior to broadcasting on the street television device 20, and a memory 18b which becomes a space for executing programs, a communication interface (hereinafter referred to as “I/F”) 19a which consists of a terminal for connecting to the network such as the Internet, and a connection I/F 19b which consists of a connection connector for connecting the selling machine 10 and the street television device 20, and these respective configuration requirements are electrically connected.

The acceptance monitor 11 and the speaker 12 display the operation guidance of the selling machine 10, according to instructions from the system control unit 17. The coin/note inlet 13 sends a paying-in signal and a paying-out signal to and receives the signals from the system control unit 17, and performs a settlement process. The acceptance operation unit 14 outputs an operation signal inputted by a user through the keyboard, the touch panel or the like, to the system control unit 17. The media slot 15 accepts an insertion of the medium 15a which has stored the contents file thereon, and the system control unit 17 reads the contents file and stores it in the HDD 18. The printer unit 16 prints an amount which has been paid in, according to the instructions from the system control unit 17, and moreover, the printer unit 16 prints contract contents such as a preferred broadcast time which has been inputted through the acceptance operation unit 14, on a paper medium (receipt). The system control unit 17 controls to eject the receipt, and the change required with respect to the amount which has been inputted through the coin/note inlet 13, to the outlet 16a.

The street television device 20 includes the large monitor 21, the speaker 22 and a connection I/F 29b which consists of the connection connector. The connection I/F 19b of the selling machine 10 and the connection I/F 29b of the street television device 20 are electrically connected via a coaxial cable or the like. The system control unit 17 of the selling machine 10 outputs a control signal, a video signal and a sound signal to the street television device 20. The street television device 20 displays an image based on the received video signal on the large monitor 21, and outputs the sound based on the sound signal through the speaker 22. The street television device 20 may be a television device including a monitor equipped with transport facilities such as a train or a bus.

The censor server device 30 includes an operation unit 34 which consists of the keyboard or a mouse for inputting instructions for the censor server device 30, a server control unit 37 which performs the operational control, a HDD 38 which stores received contents information, a memory 38b, a monitor 31 which displays the received contents information for confirmation, and a communication I/F 39a for sending and receiving data.

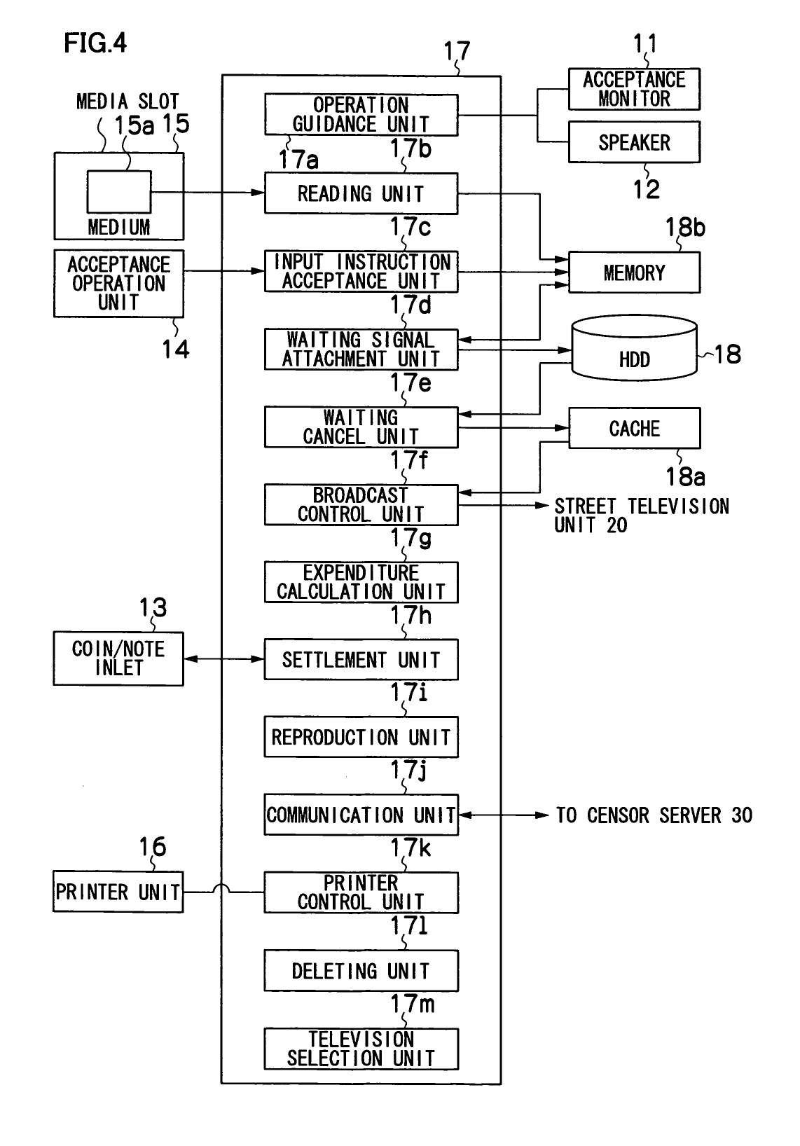

Next, based on FIG. 4, the programs executed by the system control unit 17 of the selling machine 10 will be described. FIG. 4 is a block diagram showing a configuration of the programs executed by the system control unit 17.

The programs include an operation guidance unit 17a which controls to display the operation guidance of the selling machine 10 or to output a sound guidance with respect to the user, a reading unit 17b which reads the contents file recorded on the medium 15a inserted into the media slot 15, an input instruction acceptance unit 17c which accepts an input instruction from the acceptance operation unit 14, a waiting signal attachment unit 17d which attaches a broadcast waiting signal to the contents file read by the reading unit 17b and stores the contents file in the HDD 18, a waiting cancel unit 17e which reads the contents file from the HDD 18, cancels its waiting signal and loads the contents file into the cache 18a, a broadcast control unit 17f which sends the contents file in the cache 18a to the street television device 20 to broadcast the contents file, an expenditure calculation unit 17g which calculates an expenditure required for broadcasting on the street television device 20, a settlement unit 17h which sends the paying-in signal and the paying-out signal to and receives the signals from the coin/note inlet 13 and performs the settlement process, a reproduction unit 17i which generates copy information of the contents file read by the reading unit 17b, a communication unit 17j which sends the data to and receives the data from the censor server device 30, a printer control unit 17k which controls the printer unit 16 which prints a settlement amount settled by the settlement unit 17h on the paper medium, a deleting unit 171 which deletes the contents file which has become unnecessary, and a television selection unit 17m for selecting the street television device 20 on which the user prefers to broadcast. In the first embodiment, the television selection unit 17m is not essential, however it will become essential in the second embodiment.

The system control unit 17 loads these programs on the memory 18b and executes them. The system control unit 17 may be configured with an ASIC which realizes these functions.

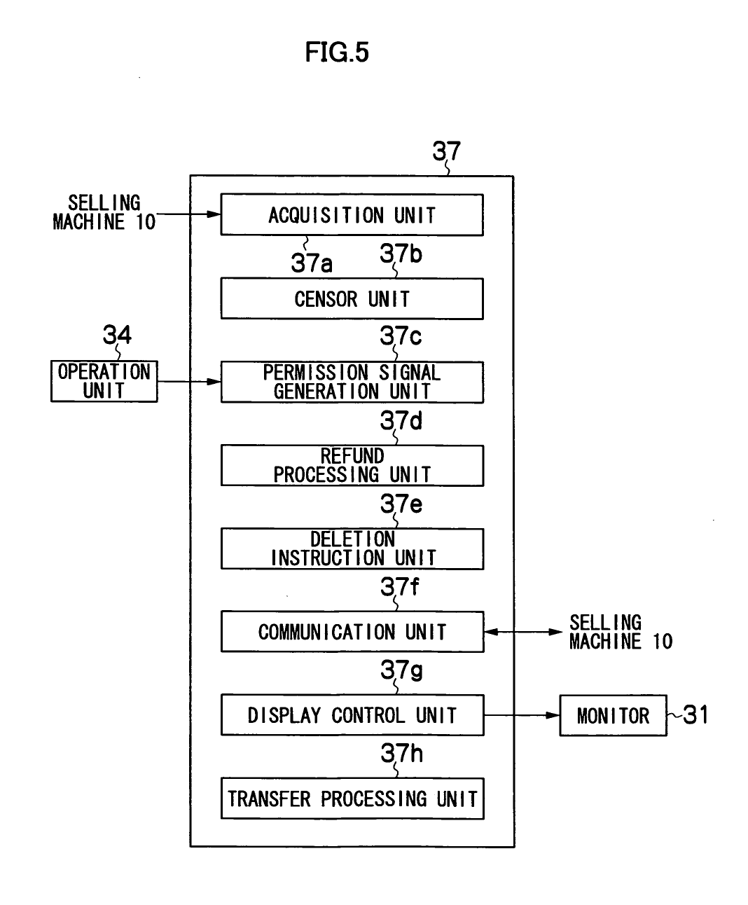

Next, based on FIG. 5, the programs executed by the server control unit 37 of the censor server device 30 will be described. FIG. 5 is a block diagram showing a configuration of the programs executed by the server control unit 37.

The programs include an acquisition unit 37a which acquires the contents file by receiving it from the selling machine 10 or reading it from the HDD 38, a censor unit 37b which determines whether or not the contents file corresponds to a predetermined broadcast prohibited condition, a permission signal generation unit 37c which generates a permission signal if the censor unit 37b determines that the contents file does not correspond to the broadcast prohibited condition or if an censor inputs information indicating permission for the broadcast through the operation unit 34, a refund processing unit 37d which performs a refund process if it is determined that the broadcast is prohibited according to a result of censoring by the censor unit 37b or a result of censoring by the censor, a deletion instruction unit 37e which instructs to delete the contents stored in the HDD 18 of the selling machine 10 if it is determined that the broadcast is prohibited, a communication unit 37f for sending the data to and receiving the data from the selling machine 10, a display control unit 37g which displays the contents acquired by the acquisition unit 37a on the monitor 31, and a transfer processing unit 37h which performs a transfer process of the contents file and the like based on the result of censoring by the censor unit 37b or the censor. Among these programs, the transfer processing unit 37h is not essential, however it will become essential in the second embodiment.

[Process Flow]

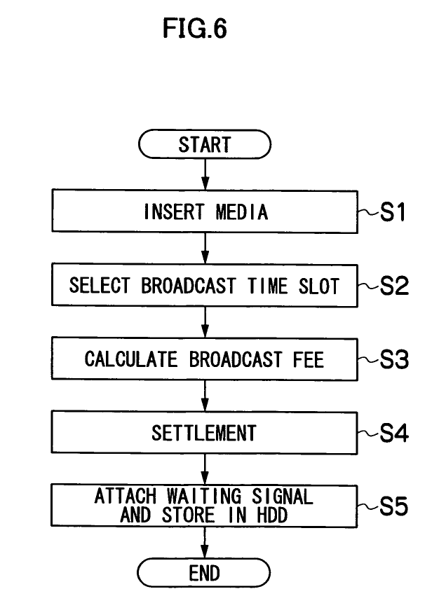

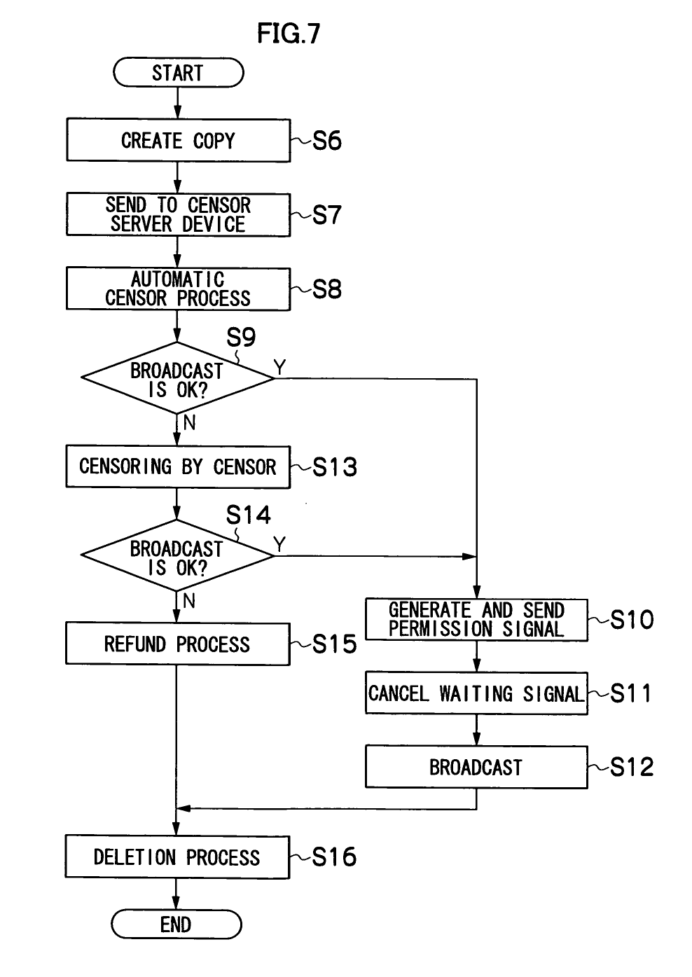

Based on FIGS. 6 to 13, a process flow will be described. FIG. 6 is a flowchart showing the process flow of selling the broadcast time through the selling machine 10. FIG. 7 is a flowchart showing the process flow after selling the broadcast time through the selling machine 10. Hereinafter, the respective steps of FIG. 6 and FIG. 7 will be described in order.

(Step S1)

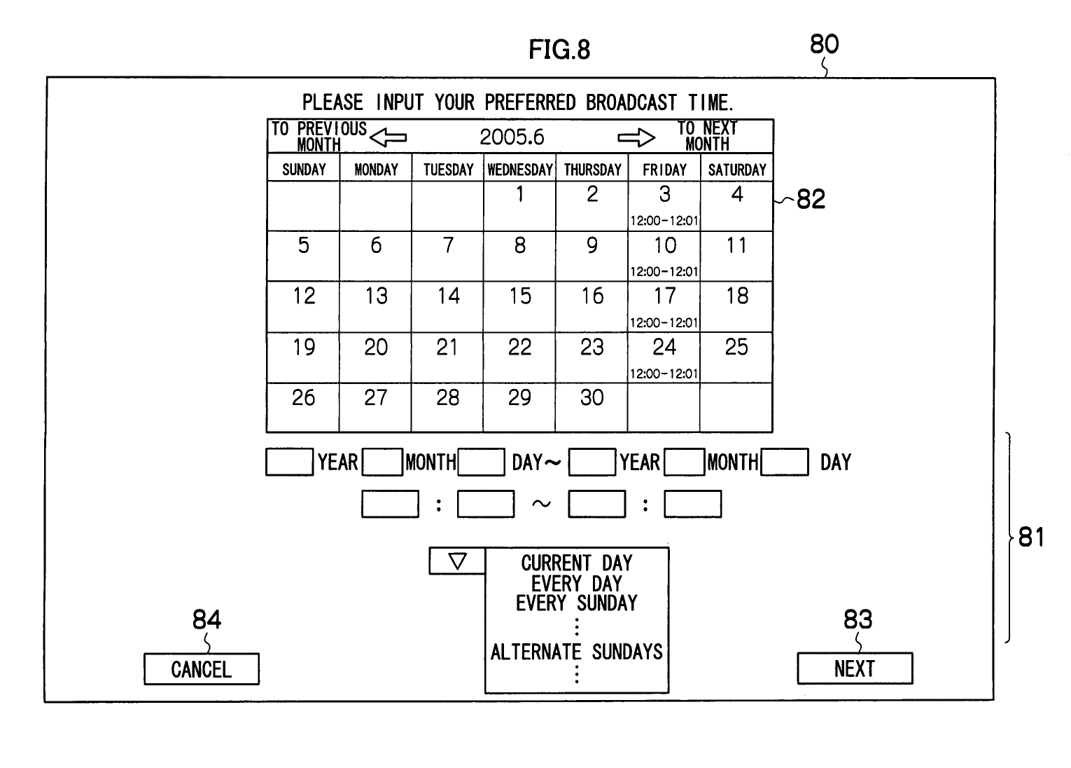

The user inserts the medium 15a in which the contents file preferred to be broadcasted is recorded, into the media slot 15 of the selling machine 10. The reading unit 17b reads the contents file from the medium 15a. The operation guidance unit 17a displays a broadcast time input screen 80 of FIG. 8. on the acceptance monitor 11, and outputs the sound guidance through the speaker 12. The broadcast time input screen 80 includes a region 81 for inputting a preferred broadcast time, a region 82 for displaying a current reservation status, a “Next” button 83 which consists of a soft icon for transiting to the next screen, and a “Cancel” button 84 for canceling the operation.

(Step S2)

The user operates the acceptance operation unit 14 and inputs a preferred broadcast time slot on the broadcast time input screen 80 (S2). The user inputs “Broadcast start date”, “Broadcast end date”, “Broadcast time” and “Broadcast pattern” such as current day, every day, every Sunday or the like. The input instruction acceptance unit 17c accepts the input instruction from the acceptance operation unit 14, and temporarily stores the input instruction in the memory 18b. When the input of the broadcast time is completed, the user operates the “Next” button 83.

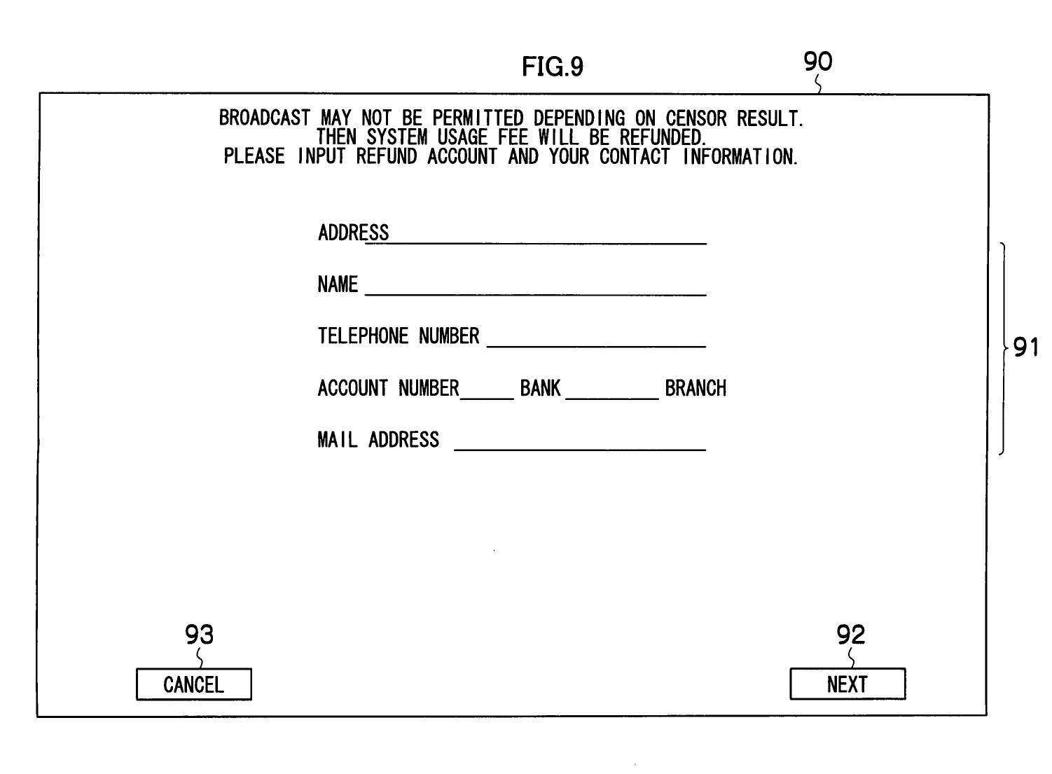

The operation guidance unit 17a displays a contact information input screen 90 of FIG. 9, and outputs the sound guidance. The contact information input screen 90 includes a region 91 for inputting contact information, a “Next” button 92, and a “Cancel” button 93. In the region 91 for inputting the contact information, “Address”, “Name”, “Telephone number”, “Account number” to which the refund is transferred when it occurs, and “Mail address” of the user are inputted. The input instruction acceptance unit 17c accepts the input instruction from the acceptance operation unit 14, and temporarily stores the input instruction in the memory 18b. When the input of the contact information is completed, the user operates the “Next” button 92.

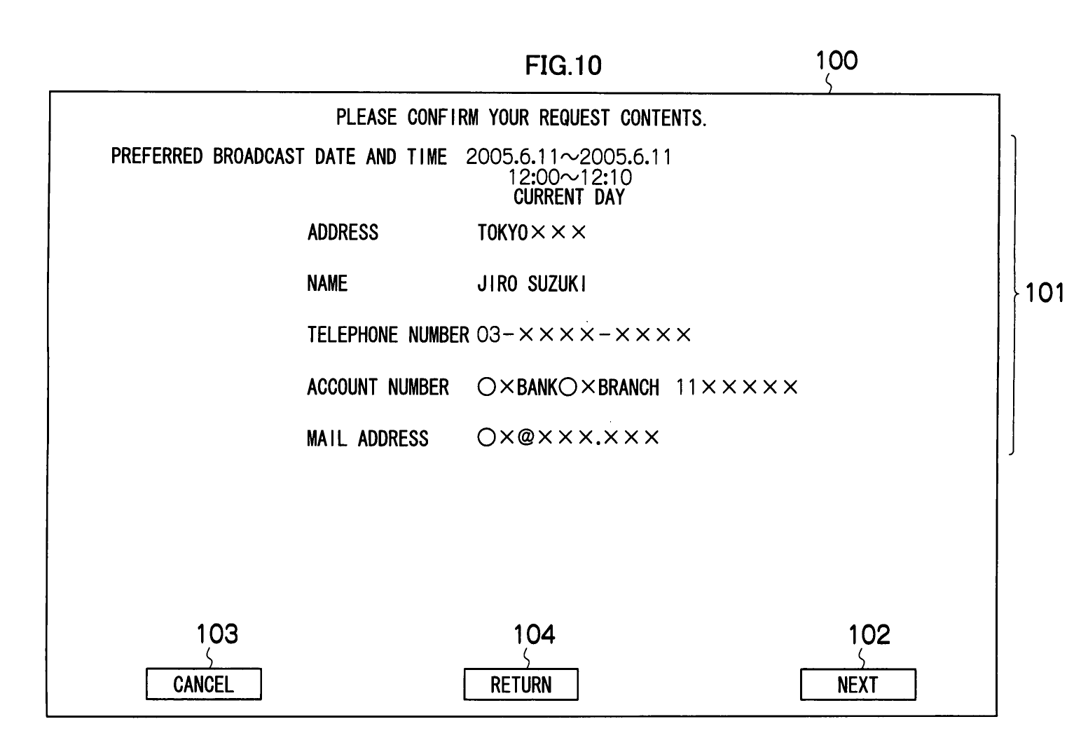

The operation guidance unit 17a displays a confirmation screen 100 of FIG. 10. The confirmation screen 100 includes a region 101 which shows the information accepted by the input instruction acceptance unit 17c, a “Next” button 102, a “Cancel” button 103, and a “Back” button 104 for transiting to the previous screen. The user confirms the input information on the confirmation screen 100, and if the contents are correct, the user operates the “Next” button 102. If the user hopes to correct the contents, the user operates the “Back” button 104 to display the previous screen and corrects the contents.

(Step S3)

The expenditure calculation unit 17g calculates the broadcast fee with respect to the broadcast time inputted at S2 (S3). The expenditure calculation unit 17g calculates the fee as a function of an audience number which may be expected in the case of broadcasting at the broadcast time inputted at S2. For example, the broadcast fee is calculated based on whether a neighborhood of the location in which the street television device 20 is installed is crowded with people or not, the broadcast time slot, or the like. The broadcast fee includes a “System usage fee” which is an expenditure for broadcasting the contents by use of the street television device 20, and a “Censor service fee” which is an expenditure for receiving a censor service. If the “System usage fee” and the “Censor service fee” are set as fixed fees, the expenditure calculation unit 17g is not an essential configuration requirement.

(Step S4)

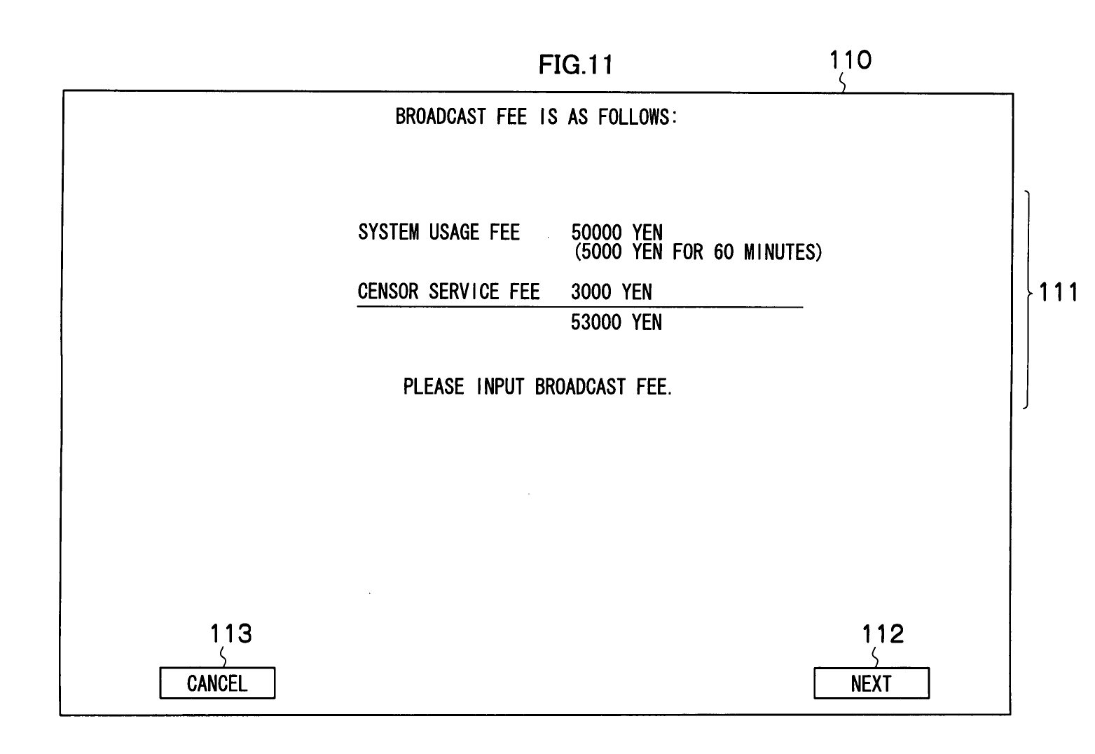

The settlement unit 17h displays the broadcast fee calculated at S3, or the fixed fees on a fee display screen 110 shown in FIG. 11. The fee display screen 110 includes a region 111 which displays details of the broadcast fee, a “Next” button 112, and a “Cancel” button 113. The user inputs a required broadcast fee into the coin/note inlet 13. The settlement unit 17h calculates the amount inputted in the coin/note inlet 13, ejects necessary change to the outlet 16a, and performs the settlement process (S4). The user inputs the broadcast fee, and operates the “Next” button 112.

(Step S5)

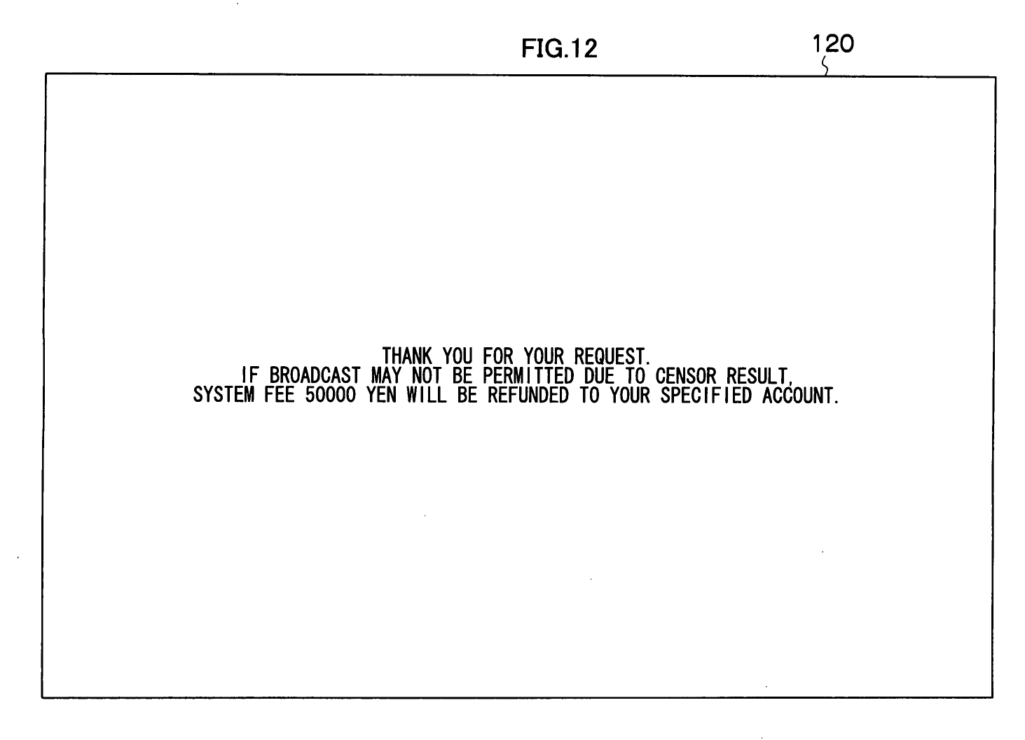

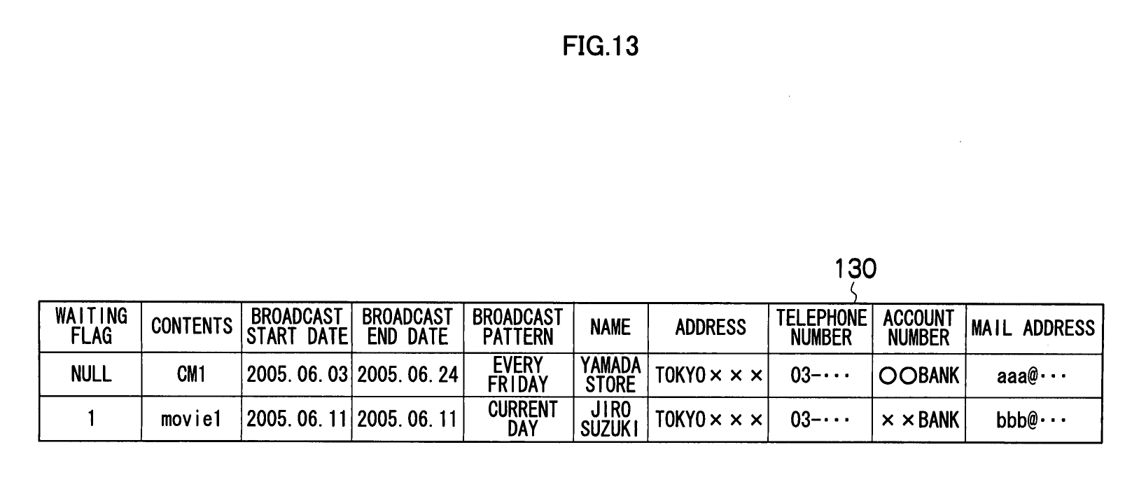

The operation guidance unit 17a displays an ending screen 120 of FIG. 12. The waiting signal attachment unit 17d attaches a waiting flag as the broadcast waiting signal to the contents file loaded into the memory 18b, and stores the contents file in the HDD 18. The contents file is stored in association with the broadcast time and the contact information also loaded into the memory 18b. FIG. 13 is a pattern diagram showing a structure of a contents file management DB 130 to be stored in the HDD 18. In the contents file management DB 130, the contents file, in which “1” is inputted in a “Waiting flag” record, shows that the contents file is in a broadcast waiting state. The contents file, in which the “Waiting flag” record is “NULL”, shows that the contents file receives the permission signal from the censor server device 30 which will be described below and is in a status having the waiting signal canceled. Moreover, the printer control unit 17k controls to the printer unit 16 to issue the receipt, in which sold contents such as the settlement amount, the broadcast time and the like are printed, and to eject the receipt to the outlet 16a. As described above, the process flow is terminated in which the user purchases the broadcast time on the street television device 20 through the selling machine 10.

When the user purchases the broadcast time on the street television device 20 through the selling machine 10, the selling machine 10 and the censor server device 30 determine whether the contents file has the substance appropriate to be broadcasted, and based on the result of the determination, a broadcast process or the refund process due to the non-permitted broadcast is performed. This process flow will be described based on FIG. 7.

(Step S6)

The reproduction unit 17i of the selling machine 10 generates a copy of the contents file stored in the HDD 18 (hereinafter referred to as “copy file”) (S6).

(Step S7)

The communication unit 17j of the selling machine 10 sends the copy file to the censor server device 30 via the communication I/F 19a (S7). The communication unit 37F of the censor server device 30 receives the copy file via the communication I/F 39a, and the acquisition unit 37a loads the copy file into the memory 38b.

(Step S8)

The censor unit 37b determines whether the copy file loaded into the memory 38b corresponds to the predetermined broadcast prohibited condition (S8). For the broadcast prohibited condition, for example, a condition may be provided in which the contents file attached with a copy protection function corresponds to the broadcast prohibited condition. It is because it may infringe a copyright if the contents file attached with the copy protection function is broadcasted on the street television device 20, which corresponds to a public transmission in view of the copyright. In addition, the image which is offensive to public order and morals may be automatically detected and determined that the image corresponds to the broadcast prohibited condition.

(Step S9)

As a result of an automatic censor process at S8, if the copy file does not correspond to any broadcast prohibited condition, the process proceeds to S10. If the copy file corresponds to even only one broadcast prohibited condition, the process proceeds to S13 (S9).

(Step S10)

The permission signal generation unit 37c generates the permission signal for canceling the “Waiting flag” in the contents file management DB 130 in the HDD 18 of the selling machine 10, and sends the permission signal to the selling machine 10 (S10).

(Step S11)

When the communication unit 17j of the selling machine 10 receives the permission signal, the waiting cancel unit 17e alters the “Waiting flag” record in the contents file management DB 130 in the HDD 18 from “1”to “NULL” (S11).

(Step S12)

The broadcast control unit 17f reads the contents file, in which the waiting state is canceled, out to the cache 18a before the broadcast time, and when it is the broadcast time, the broadcast control unit 17f sends the contents file out to the street television device 20. The street television device 20 displays the contents file on the large monitor 21 and outputs the sound through the speaker 22 in the broadcast time slot. Then the process proceeds to S16.

(Step S13)

The censor censors the copy file which has been determined that it may not be broadcasted, as the result of the automatic censor process by the censor unit 37b. The censor instructs to display the copy file through the operation unit 34, and displays the copy file on the monitor 31 to confirm the contents of the copy file (S13).

(Step S14)

If the censor determines that the copy file may be broadcasted, the censor inputs an instruction for generating the permission signal through the operation unit 34. Then the process proceeds to S10. If the censor determines that the copy file may not be broadcasted, a censor non-permission signal is generated and sent to the selling machine 10. Then the process proceeds to S15 (S14).

(Step S15)

The refund processing unit 37d requests the selling machine 10 to send the contact information and the account number of the user who have requested to broadcast the copy file for which the permission signal may not be generated. In response to the request, the waiting cancel unit 17e of the selling machine 10 extracts the contact information and the account number from the HDD 18, and send them to the censor server device 30. The refund processing unit 37d transfers an amount corresponding to the above described system usage fee for which the refund is required, to the account number (S15). Furthermore, the refund processing unit 37d sends an e-mail which informs that the broadcast may not be performed, with respect to the mail address of the user. The deletion instruction unit 37e sends a deletion signal for deleting the contents file which may not be broadcasted, with respect to the selling machine 10, and also deletes the copy file.

(Step S16)

If the broadcast of the contents file in the broadcast time slot has been terminated, and if the deletion signal has been received, the deleting unit 17l deletes the contents file of which the broadcast has been terminated, from the HDD 18. Then the process is terminated.

According to the above described embodiment, it is possible to broadcast the censored contents only by specifying the broadcast time and inputting the fee at the selling machine 10. Accordingly, it is possible to solve cumbersomeness in a contract procedure and to enable everyone to readily utilize the street television device.

It should be noted that although both of the automatic censor process by the censor server device 30 and the censor process by the censor have been performed in the above described embodiment, only one of those may be performed. In that case, only one of the process of S8 and S9 and the process of S13 and S14 may be performed.

Moreover, the censor process is not essential in a sequence of processes of the broadcast system. For example, the censor process is previously performed, a censored flag (which also may be the permission signal) is attached to the contents file which has been determined to be permitted to be broadcasted, and the contents file is stored in the medium 15a. Then, when the system control unit 17 of the selling machine 10 reads the contents file through the media slot 15 and detects the censored flag, the broadcast control unit 17f performs the broadcast process. The detection of the censored flag may be performed by the waiting cancel unit 17e, or a program for detecting the censored flag (a censored flag detection unit) may be provided. In this case, since it is not necessary to perform the censor process, it is not necessary for the selling machine 10 to generate the copy of the contents file and send it to the censor server device 30. Accordingly, for example, if the contents which have been permitted to be broadcasted once by the censor server device 30 is broadcasted again, it would not be necessary to perform the censor process twice with respect to the same contents. Moreover, also if the contents file which has been censored by a censor business is broadcasted via the selling machine 10, it is possible to avoid repeating the censor process.

### Second Embodiment

[General Configuration of the System]

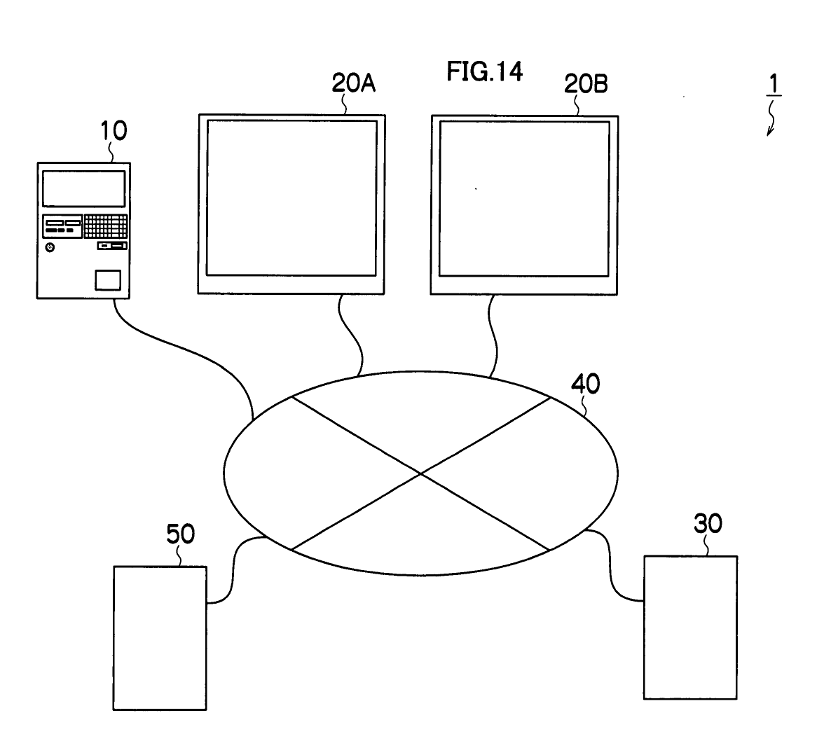

Based on FIG. 14, the broadcast system 1 according to the second embodiment will be described. In the broadcast system 1 according to this embodiment, the selling machine 10, a plurality of street television devices 20A, B, and a broadcast server device 50 which controls to broadcast on the plurality of street television devices 20A, B are connected to the network 40. The user specifies which of the street television devices 20 broadcasts the contents file, at the selling machine 10. The broadcast server device 50 receives the contents file which has been permitted to be broadcasted, from the censor server device 30, and controls to broadcast the contents file on the street television device 20 specified by the user.

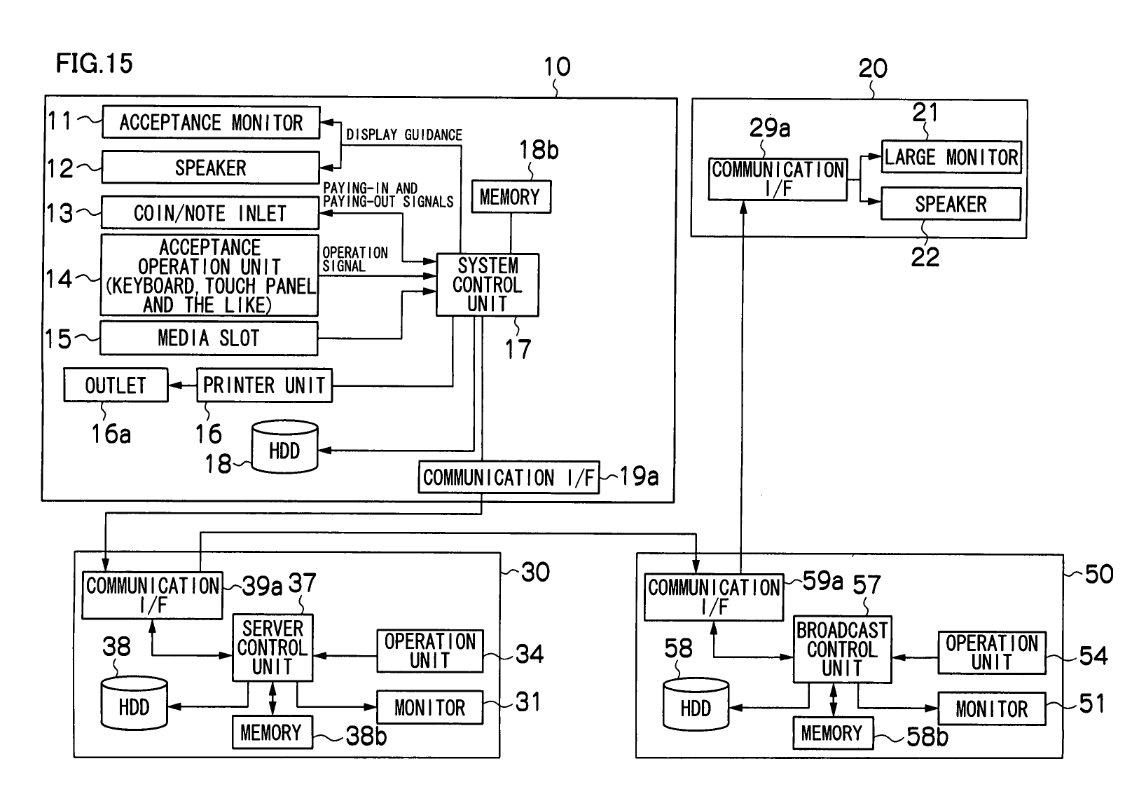

Next, based on FIG. 15, hardware configurations of the selling machine 10, the censor server device 30 and the broadcast server device 50 according to this embodiment will be described. FIG. 15 is a block diagram showing the hardware configurations of the selling machine 10, the censor server device 30 and the broadcast server device 50 according to this embodiment.

The selling machine 10 includes the acceptance monitor 11, the speaker 12, the coin/note inlet 13, the acceptance operation unit 14, the media slot 15, the printer unit 16 and the outlet 16a, the system control unit 17, the HDD 18, the memory 18b and the communication I/F 19a, and these respective configuration requirements are electrically connected.

The street television device 20 includes the large monitor 21, the speaker 22 and a communication I/F 29a, and these are electrically connected.

The censor server device 30 includes the monitor 31, the operation unit 34, the server control unit 37, the HDD 38, the memory 38b, and the communication I/F 39a.

The broadcast server device 50 includes a monitor 51, an operation unit 54, a broadcast control unit 57, a HDD 58, a memory 58b, and a communication I/F 59a.

The system control unit 17 of the selling machine 10 executes the operation guidance unit 17a, the reading unit 17b, the input instruction acceptance unit 17c, the expenditure calculation unit 17g, the settlement unit 17h, the communication unit 17j, the printer control unit 17k, and the television selection unit 17m for selecting the street television device 20 on which the user prefers to broadcast by the user, in the program block diagram of FIG. 4.

The server control unit 37 of the censor server device 30 executes the programs consisting of the acquisition unit 37a, the censor unit 37b, the communication unit 37f, and the transfer processing unit 37h, which instructs to transfer the contents file to the broadcast server device 50 if the censor unit 37b determines that the contents file does not correspond to the broadcast prohibited condition, and which transfers the contact information to the broadcast server device 50 if the contents file corresponds to the broadcast prohibited condition, in the program block diagram of FIG. 5.

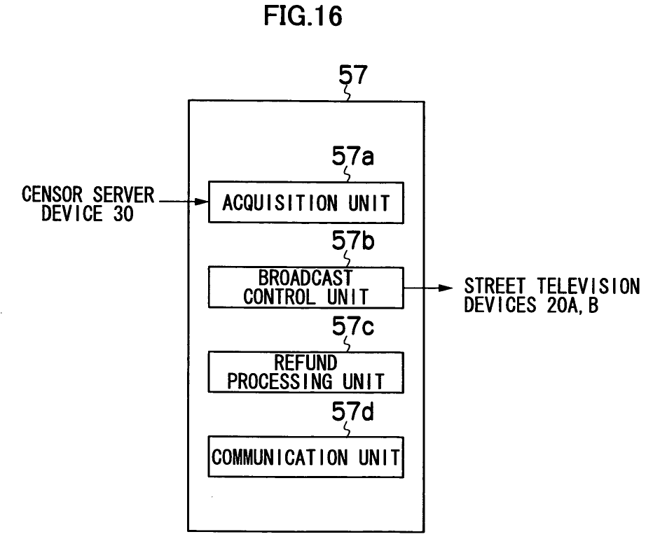

The broadcast control unit 57 of the broadcast server device 50 loads programs shown in FIG. 16 into the memory 58b, and executes them. Next, based on FIG. 16, the programs executed by the broadcast control unit 57 will be described. The programs are performed by an acquisition unit 57a which acquires the contents file from the censor server device 30, a broadcast control unit 57b which broadcasts the contents file in the broadcast time slot specified at the street television devices 20A, B which have been specified by the user, a refund processing unit 57c which performs the refund process if the broadcast has not been permitted, and a communication unit 57d for sending the data to and receiving the data from the censor server device 30 and the street television devices 20A, B. The refund processing unit 57c executes the process similar to the refund processing unit 37d of the first embodiment.

[Process Flow]

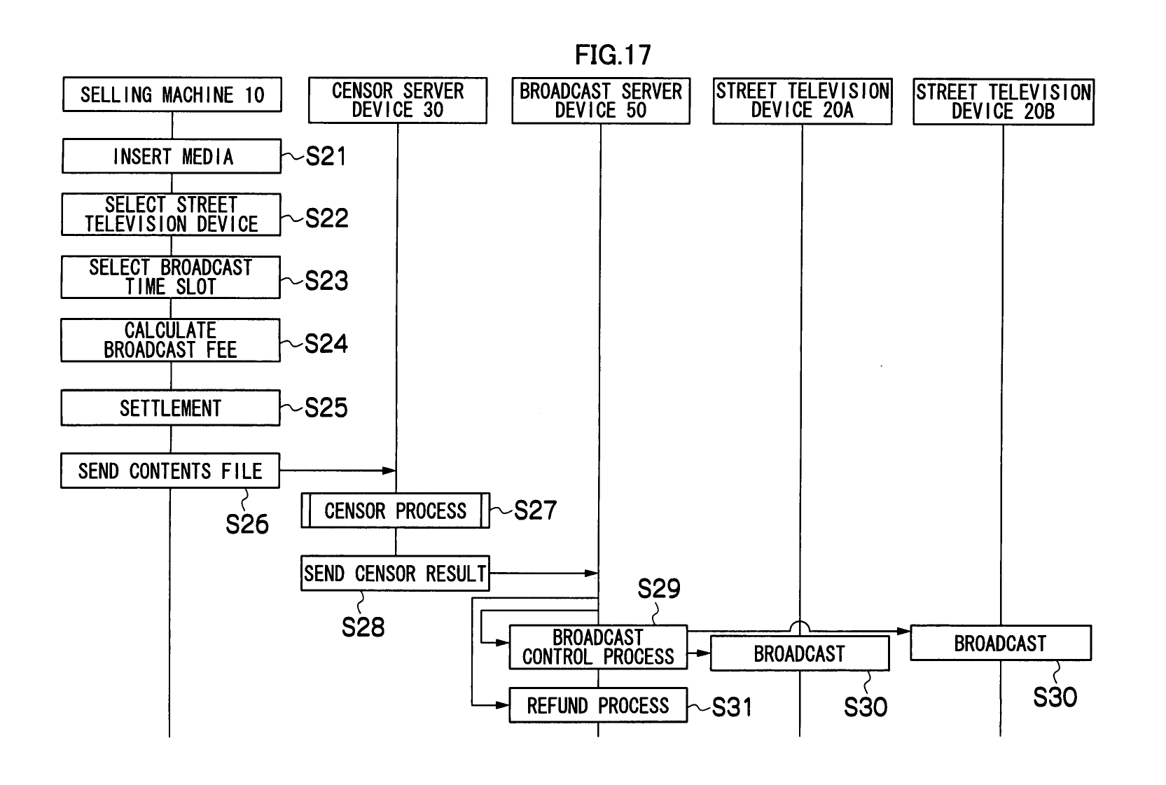

Based on FIG. 17, a process flow of the second embodiment will be described. FIG. 17 is a sequence diagram illustrating the process flow of this embodiment.

At S21, as similar to S1, the user stores the medium 15a, in which the contents file preferred to be broadcasted is recorded, into the media slot 15 of the selling machine 10, and the system control unit 17 reads the contents file (S21).

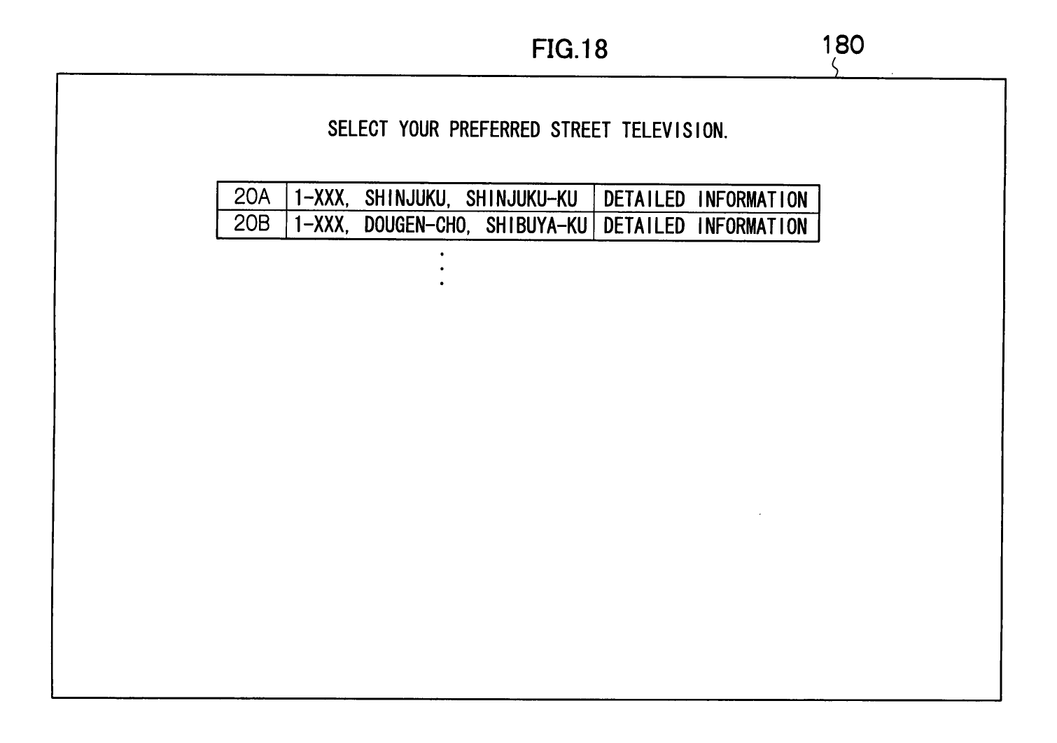

At S22, the television selection unit 17m of the system control unit 17 displays a television selection screen 180 shown in FIG. 18 on the acceptance monitor 11. On the television selection screen 180, soft buttons for displaying detailed information, such as installation addresses of the street television devices 20A, B, sizes of the street television devices 20A, B, expected audience numbers, the broadcast fees and the like, are displayed. The broadcast fees of the street television devices 20A, B may be set individually. The information on the street television devices 20A, B may be previously stored in the HDD 18 of the selling machine 10, or the information on the street television devices 20A, B may be received and displayed from the broadcast server device 50 every time the user operates the selling machine 10. The user selects the street television devices 20A, 20B on which the user prefers to broadcast (S22). This selection may be one of the street television devices 20A and B, or may be the plurality of the street television devices 20A, B.

At S23 to 25, as similar to S2 to 4, the broadcast time is selected (S23), the broadcast fee is calculated (S24), and the settlement is made (S25). At S26, the selling machine 10 sends the contents file, as well as selection result information on the preferred street television devices 20A, B inputted by the user, broadcast time information, and the contact information, with respect to the censor server device 30 (S26).

At S27, based on the contents file which the acquisition unit 37a of the censor server device 30 has received from the selling machine 10 and then the censor unit 37b has received, the censor process is performed (S27). The censor process performs the process similar to S8 to S14 of the first embodiment.

At S28, the transfer processing unit 37h transfers information required for the following process in the broadcast server device 50, depending on a result of censoring (S28). As the result of censoring by the censor unit 37b or the censor, if the contents file does not correspond to the broadcast prohibited condition, the transfer processing unit 37h instructs to transfer the contents file, the broadcast time information, and the selection result information on the preferred street television devices 20A, B to the broadcast server device 50. If the contents file corresponds to the broadcast prohibited condition, the transfer processing unit 37h instructs to transfer the contact information required for performing the refund process to broadcast server device 50. The communication unit 37f sends the contents file, the broadcast time information, and the selection result information on the preferred street television devices 20A, B or the contact information to the broadcast server device 50, according to the instruction from the transfer processing unit 37h. The censor server device 30 may delete the contents file after the transfer process.

At S29, the acquisition unit 57a of the broadcast server device 50 receives the contents file, the broadcast time information, and the selection result information on the preferred street television devices 20A, B, or the contact information, from the censor server device 30. If the contents file, the broadcast time information, and the selection result information on the preferred street television devices 20A, B are received, the broadcast control unit 57b sends the video signal and the sound signal to the street television devices 20A, B in the broadcast time slot specified by the user (S29). The street television devices 20A, 20B receive the video signal and the sound signal via the communication I/F 29a, display the video on the large monitor 21, and outputs the sound through the speaker 22 (S30). When the broadcast is terminated, the broadcast server device 50 may delete the information such as the contents file and the like, which has become unnecessary.

When the acquisition unit 57a of the broadcast server device 50 receives the contact information from the censor server device 30, the process proceeds to S31. At S31, as similar to S15 of the first embodiment, the refund processing unit 57c performs the refund process for the user, based on the received contact information (S31). When the refund process is terminated, the broadcast server device 50 may delete the information such as the contents file and the like, which has become unnecessary.

According to this embodiment, the user can select one or more of the preferred street television devices through the selling machine 10 to broadcast the contents in the preferred broadcast time slot.

### Third Embodiment

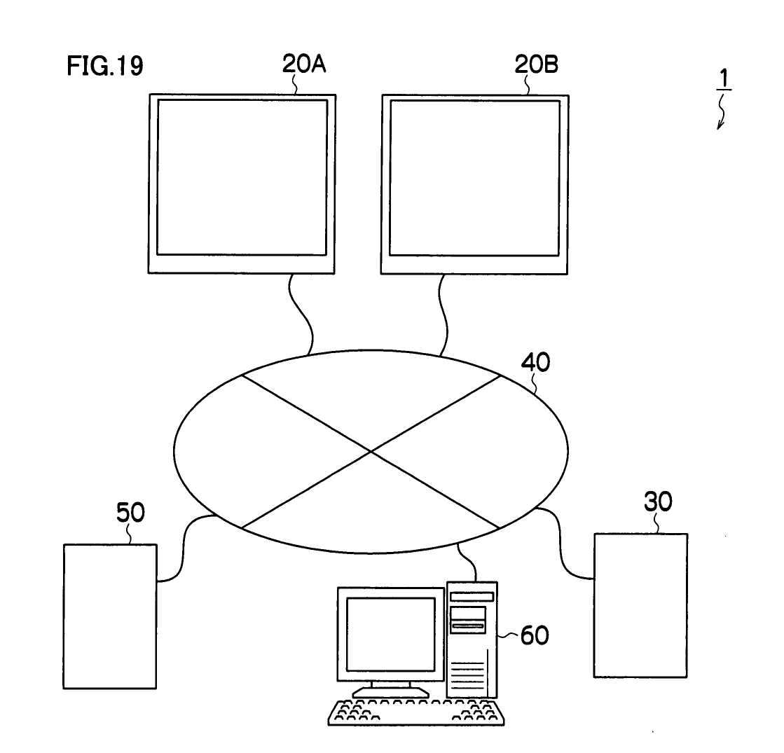

Based on FIG. 19, the broadcast system 1 according to the third embodiment will be described. In the broadcast system 1 according to this embodiment, the plurality of street television devices 20A, B, a broadcast server device 50 which controls to broadcast on the plurality of street television devices 20A, B, and a terminal device 60 which consists of a personal computer or a PDA at home of the user, are connected to the network 40. The user specifies which of the street television devices 20 broadcasts the contents file, at the terminal device 60. The broadcast server device 50 receives the contents file which has been permitted to be broadcasted, from the censor server device 30, and controls to broadcast the contents file on the street television device 20 specified by the user.

The user accesses the broadcast server device 50 via the network 40 such as the Internet from the terminal device 60, and acquires the screens for inputting the information required for purchasing a broadcast right, for example, such as the above described FIGS. 8, 9, 10 and 11. According to the screens displayed on the terminal device 60, the user sends the selection information on the preferred street television, the broadcast time information, the settlement information with respect to the broadcast of the contents, the contact information for the refund, and the contents file information, to the broadcast server device 50. For the settlement, a credit card number may be sent, or a net settlement with an Internet banking may be utilized. The process flow of the terminal device 60, the censor server device 30, the broadcast server device 50, and the street television devices 20A, 20B is similar to the case where the selling machine 10 of FIG. 17 is replaced with the terminal device 60.

According to this embodiment, the user can purchase the broadcast right from the terminal device such as the personal computer at home, and it is possible to improve convenience without having to go to the location where the broadcast time selling machine is installed.

What is claimed is:

1. A broadcast system, comprising:
a street television device, and
a broadcast time selling machine connected to the street television device, which sells a broadcast time for broadcasting desired contents,
wherein the broadcast time selling machine comprises:
a reading device which reads a contents file in which the contents are recorded;
a storage device which stores the contents file;
an input device which accepts an input of the broadcast time at which the contents are preferred to be broadcasted from a user;
a settlement device which makes settlement of an expenditure required for broadcasting the contents; and
a control device which controls to broadcast the contents on the street television device at the broadcast time.

2. The broadcast system according to claim 1, further comprising:
a waiting signal attachment device which attaches a waiting signal for indicating that the broadcast is waited for, to the contents file stored in the storage device; and
a permission signal acquisition device which acquires a permission signal for canceling the waiting signal and permitting the broadcast,
wherein when the permission signal is acquired, the control device cancels the waiting signal attached to the contents file, and controls to broadcast the contents on the street television device at the broadcast time.

3. The broadcast system according to claim 2, wherein a censor server device which censors the contents is connected to the broadcast time selling machine,
and wherein the broadcast time selling machine further comprises:
a replication device which generates a replication of the contents file;
a selling machine sending device which sends the replication of the contents file with respect to the censor server device; and
a selling machine receiving device which receives the permission signal from the censor server device,
and wherein the censor server device comprises:
a censor server receiving device which receives the replication of the contents file from the broadcast time selling machine;
a permission signal generation device which generates the permission signal if the broadcast is permitted, as a result of censoring the contents based on the replication of the contents file; and
a censor server sending device which sends the permission signal to the broadcast time selling machine.

4. A broadcast system in which street television devices, a broadcast time selling machine which sells a broadcast time for broadcasting desired contents on the street television devices, and a broadcast server device which controls to broadcast on the street television devices, are connected via a network,
wherein the broadcast time selling machine comprises:
a reading device which reads a contents file in which the contents are recorded;
a storage device which stores the contents file;
an input device which accepts an input of the broadcast time at which the contents are preferred to be broadcasted from a user;
a settlement device which makes settlement of an expenditure required for broadcasting the contents; and
a selling machine sending device which sends the contents file and broadcast time information indicating the broadcast time,
and wherein the broadcast server device comprises:
a broadcast server receiving device which receives the contents file and the broadcast time information; and
a control device which controls to broadcast on the street television devices at the broadcast time, based on the contents file and the broadcast time information.

5. The broadcast system according to claim 4, further comprising:
a selection device which have the user select the street television device on which the user prefers to broadcast among the street television devices,
and wherein the control device controls to broadcast on the street television device which has been selected by the selection device.

6. A broadcast system in which a terminal device, street television devices, and a broadcast server device which controls to broadcast on the street television devices, are connected via a network,
wherein the terminal device comprises:
a reading device which reads a contents file in which contents preferred to be broadcasted are recorded;
a selection device which selects the street television device on which the contents are preferred to be broadcasted;
an input device which accepts an input of a broadcast time at which the contents are preferred to be broadcasted on the street television device;
a terminal side receiving device which receives expenditure information required for broadcasting the contents; and
a terminal sending device which sends the contents file, broadcast time information indicating the broadcast time and settlement information with respect to the expenditure information,
and wherein the broadcast server device comprises:
a broadcast server receiving device which receives the contents file, the broadcast time information and the settlement information;
a control device which controls to broadcast on the street television device at the broadcast time, based on the contents file and the broadcast time information;
an expenditure calculation device which calculates an expenditure for broadcasting the contents file; and
a broadcast server sending device which sends the expenditure information indicating a calculation result by the expenditure calculation device to the terminal device.

7. The broadcast system according to claim 4, wherein a censor server device which censors the contents is connected to the network,
and wherein the selling machine sending device or the terminal sending device sends the contents file and the broadcast time information to the censor server device,
and wherein the censor server device comprises:
a censor server receiving device which receives the contents file and the broadcast time information; and
a transferring device which transfers the contents file and the broadcast time information with respect to the broadcast server device if the broadcast is permitted, as a result of censoring the contents based on the contents file.

8. The broadcast system according to claim 6, wherein a censor server device which censors the contents is connected to the network,
and wherein the selling machine sending device or the terminal sending device sends the contents file and the broadcast time information to the censor server device,
and wherein the censor server device comprises:
a censor server receiving device which receives the contents file and the broadcast time information; and
a transferring device which transfers the contents file and the broadcast time information with respect to the broadcast server device if the broadcast is permitted, as a result of censoring the contents based on the contents file.

9. The broadcast system according to claim 1, wherein the broadcast time selling machine further comprises an expenditure calculation device which calculates the expenditure required for broadcasting, based on at least one of the length of the broadcast time and an audience number which may be expected in the case of broadcasting the contents at the broadcast time, or the expenditure calculation device of the broadcast server device calculates the expenditure required for broadcasting, based on at least one of the length of the broadcast time and the audience number which may be expected in the case of broadcasting the contents at the broadcast time.

10. The broadcast system according to claim 4, wherein the broadcast time selling machine further comprises an expenditure calculation device which calculates the expenditure required for broadcasting, based on at least one of the length of the broadcast time and an audience number which may be expected in the case of broadcasting the contents at the broadcast time, or the expenditure calculation device of the broadcast server device calculates the expenditure required for broadcasting, based on at least one of the length of the broadcast time and the audience number which may be expected in the case of broadcasting the contents at the broadcast time.

11. The broadcast system according to claim 6, wherein the broadcast time selling machine further comprises an expenditure calculation device which calculates the expenditure required for broadcasting, based on at least one of the length of the broadcast time and an audience number which may be expected in the case of broadcasting the contents at the broadcast time, or the expenditure calculation device of the broadcast server device calculates the expenditure required for broadcasting, based on at least one of the length of the broadcast time and the audience number which may be expected in the case of broadcasting the contents at the broadcast time.

12. The broadcast system according to claim 1, wherein the broadcast time selling machine or the terminal device further comprises a contact information acceptance device which accepts an input of contact information required for performing a refund process with respect to the user;
the selling machine sending device or the terminal sending device sends the contact information to any one of the broadcast time selling machine, the censor server device and the broadcast server device; and
any one of the broadcast time selling machine, the censor server device and the broadcast server device further comprises a refund processing device which receives the contact information and performs the refund process based on the contact information.

13. The broadcast system according to claim 4, wherein the broadcast time selling machine or the terminal device further comprises a contact information acceptance device which accepts an input of contact information required for performing a refund process with respect to the user;
the selling machine sending device or the terminal sending device sends the contact information to any one of the broadcast time selling machine, the censor server device and the broadcast server device; and
any one of the broadcast time selling machine, the censor server device and the broadcast server device further comprises a refund processing device which receives the contact information and performs the refund process based on the contact information.

14. The broadcast system according to claim 6, wherein the broadcast time selling machine or the terminal device further comprises a contact information acceptance device which accepts an input of contact information required for performing a refund process with respect to the user;
the selling machine sending device or the terminal sending device sends the contact information to any one of the broadcast time selling machine, the censor server device and the broadcast server device; and
any one of the broadcast time selling machine, the censor server device and the broadcast server device further comprises a refund processing device which receives the contact information and performs the refund process based on the contact information.

15. The broadcast system according to claim 1, wherein any one of the broadcast time selling machine, the censor server device and the broadcast server device further comprises a deleting device which deletes the contents file of which the broadcast has been terminated or the contents file which is not permitted to be broadcasted.

16. The broadcast system according to claim 4, wherein any one of the broadcast time selling machine, the censor server device and the broadcast server device further comprises a deleting device which deletes the contents file of which the broadcast has been terminated or the contents file which is not permitted to be broadcasted.

17. The broadcast system according to claim 6, wherein any one of the broadcast time selling machine, the censor server device and the broadcast server device further comprises a deleting device which deletes the contents file of which the broadcast has been terminated or the contents file which is not permitted to be broadcasted.

18. A broadcast time selling machine, comprising:
a reading device which reads a contents file in which contents preferred to be broadcasted on a street television device are recorded;
a storage device which stores the contents file;
an input device which accepts an input of a broadcast time at which the contents are preferred to be broadcasted from a user; and
a settlement device which makes settlement of an expenditure required for broadcasting the contents file.

19. The broadcast time selling machine according to claim 18, wherein the broadcast time selling machine is connected to the street television device, further comprising:
a waiting signal attachment device which attaches a waiting signal for indicating that the broadcast is waited for, to the contents file stored in the storage device;
a permission signal acquisition device which acquires a permission signal for canceling the waiting signal and permitting the broadcast; and
a control device which cancels the waiting signal attached to the contents file when the permission signal is acquired, and controls to broadcast on the street television device at the broadcast time.

20. A censor server device, comprising:
an acquisition device which acquires a contents file in which contents preferred to be broadcasted on a street television device are recorded; and
a censor device which determines whether or not the contents file corresponds to a broadcast prohibited condition,
wherein if the broadcast is permitted as a result of censoring by the censor device, the contents file is sent with respect to the street television device on which the broadcast is performed, or a permission signal for permitting the broadcast is sent with respect to a control device which controls to broadcast on the street television device.

21. A control program of a broadcast time selling machine, causing a computer to execute:
a reading step of reading a contents file in which contents preferred to be broadcasted are recorded;
an input instruction step of accepting an input of a broadcast time for broadcasting the contents from a user;
a settlement step of making settlement of an expenditure required for the broadcast; and
a control step of controlling to broadcast the contents on a street television device.
